(19) United States
(12) Patent Application Publication
(10) Pub. No.: US 2020/0346418 A1
(43) Pub. Date: Nov. 5, 2020

(54) METHOD OF PRODUCING COMPONENTS OF A WIND TURBINE, IN PARTICULAR A WIND TURBINE ROTOR BLADE

(71) Applicant: Wobben Properties GmbH, Aurich (DE)

(72) Inventors: Florian STOPS, Neundorf (DE); Torsten BETHGE, Magdeburg (DE)

(21) Appl. No.: 16/960,838

(22) PCT Filed: Jan. 17, 2019
(86) PCT No.: PCT/EP2019/051106

§ 371 Date: Jul. 8, 2020

(30) Foreign Application Priority Data
Jan. 17, 2018 (DE) 10 2018 100 941.0

(51) Int. Cl. B29C 70/32; F03D 1/06; B29C 70/44

(52) U.S. Cl. CPC B29C 70/32; F03D 1/0675; B29L 2031/085; B29C 70/446; F05B 2230/20; B29C 70/443

(57) ABSTRACT

There is provided a method of producing a component of a wind turbine, in particular a wind turbine rotor blade. A winding core is provided on a rotatable shaft. A vacuum film is placed on the winding core. A component to be produced is wound on the vacuum film by means of a winding scrim. An external mold is placed around the wound component. A vacuum infusion method is carried out and the infused resin is cured. In that case a vacuum is generated between the vacuum film on the winding core and the inside of the external mold.

### BACKGROUND

### Technical Field

The present invention concerns a method of producing components of a wind turbine.

### Description of the Related Art

Components of wind turbines, like for example parts of the rotor blades of the wind turbine, can be produced using different methods. In that respect the parts or elements of the wind turbine can be at least partially wound in a winding method. In that case textile fabric scrims are wound around a contour-forming core. The textile scrims can be impregnated with resin, they can be in the form of a prepreg or they can be used as dry textile scrims.

FIG. 14 shows a diagrammatic view of the winding method. In that case a winding core 320 can be placed on a shaft 310. The shaft 310 is rotated so that the winding core 320 also rotates. A winding scrim 500 can then be wound on to the winding core 320 to obtain a desired component 400. That winding method can provide that the external contour of the winding core 320 is transferred on to the internal contour or the inside of the component.

The result of that however can be that an external geometry of the component does not achieve the desired external geometry.

DE 27 19 773 describes a method of producing a tubular body. A fiber material is wound on to a core mold and an external casing is externally applied. Air is then sucked out and an impregnation resin is introduced under pressure. The tubular body is then hardened and the core mold is removed from the hollow body. The external casing can then be mechanically ablated.

On the German patent application from which priority is claimed the German Patent and Trade Mark Office searched the following documents: DE 37 16 335 A1, DE 10 2010 026 018 A1, DE 10 2015 204 490 Al, DE 10 2016 110 848 A1 and EP 2 361 752 A1.

### BRIEF SUMMARY

Provided is a method of more effectively producing components of a wind turbine. In particular provide is a method of producing components of a wind turbine, in which an external geometry of the component to be produced is sufficiently flat or smooth.

Thus there is provided a method of producing a component of a wind turbine, in particular a wind turbine rotor blade. A winding core is provided on a rotatable shaft. A vacuum film is placed on the winding core. A component to be produced is wound on the vacuum film by means of a winding scrim. An external mold is placed around the wound component. A vacuum infusion method is carried out and the infused resin is cured. In that case a vacuum is generated between the vacuum film on the winding core and the inside of the external mold, so that the scrim is pressed against the inside of the external mold by means of the vacuum infusion method so that a smooth outside surface on the wound part is achieved.

According to an aspect of the present invention the external mold is of a multi-part configuration.

According to a further aspect of the present invention the winding core can be removed before the vacuum infusion method is carried out. That is advantageous because in that way the winding core can already be used elsewhere.

According to a further aspect of the present invention the finished wound component can be severed to provide separate individual segments.

Provided is a method of producing components of a wind turbine, in particular a rotor blade of a wind turbine. For that purpose there is provided a winding core and a winding scrim is wound on to the core. An external mold is then placed on the wound scrim and a vacuum is produced so that the scrim is pressed against the inside of the external mold by means of the vacuum infusion method so that this gives a smooth external surface on the wound part.

Optionally the winding core can be removed before the vacuum infusion method so that the winding core can be re-used in the interim. The method makes it possible to avoid waves and folds at the outside or on the external surface of the component to be produced as the vacuum infusion method provides that the scrim is pressed against the external mold and is thus tautened.

According to an aspect of the present invention the external mold can be of a multi-part configuration so that the component to be produced can be easily removed.

According to a further aspect of the present invention the finished component can be cut into various individual parts.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind turbine according to the invention,

FIGS. 2 to 9 diagrammatically show various steps in the production of a component for a wind turbine,

FIG. 10 shows a diagrammatic view of an external mold which was removed from the winding core,

FIG. 11 shows a diagrammatic view of a finished component,

FIG. 12 shows a diagrammatic view of the component and a multi-part external mold,

FIG. 13 shows a diagrammatic view of a multi-part component, and

FIG. 14 shows a diagrammatic view of the production of a component according to the state of the art.

### DETAILED DESCRIPTION

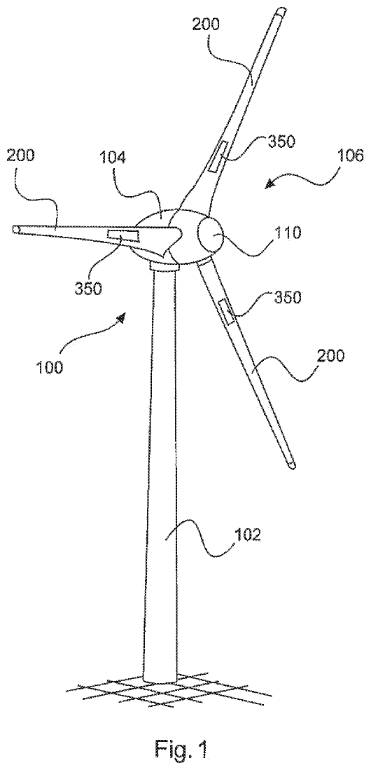

FIG. 1 shows a diagrammatic view of a wind turbine according to the invention. The wind turbine 100 has a tower 102 and a nacelle 104. Provided on the nacelle 104 is a rotor 106 having three rotor blades 200 and a spinner 110. The rotor 106 is caused to rotate by the wind in operation and drives a generator in the nacelle 104 to generate electrical energy. The rotor blade 200 has at least one component 350 which is produced according to the invention.

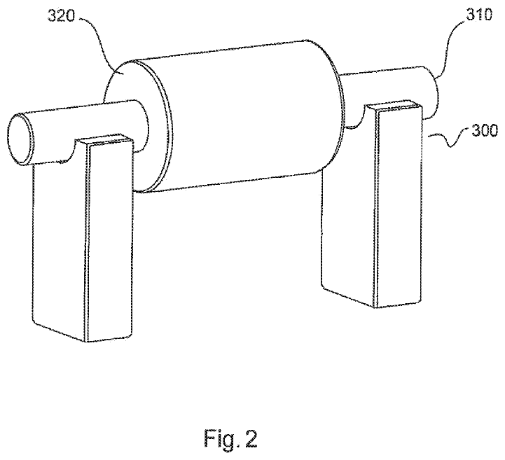

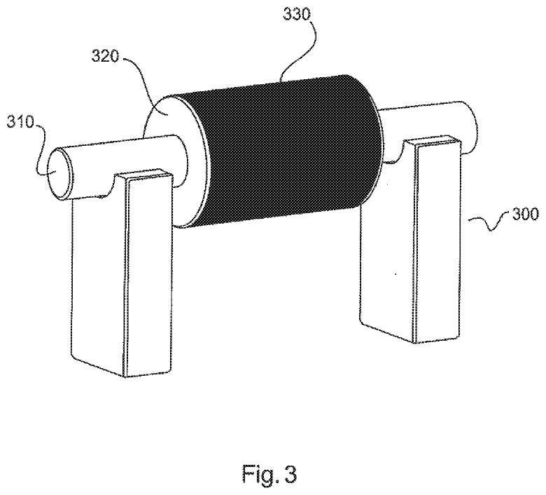

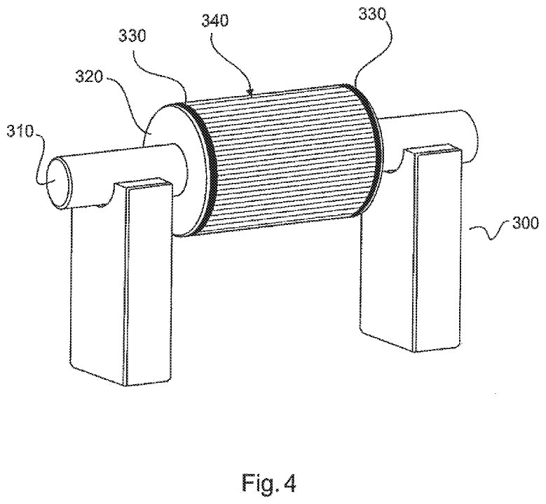

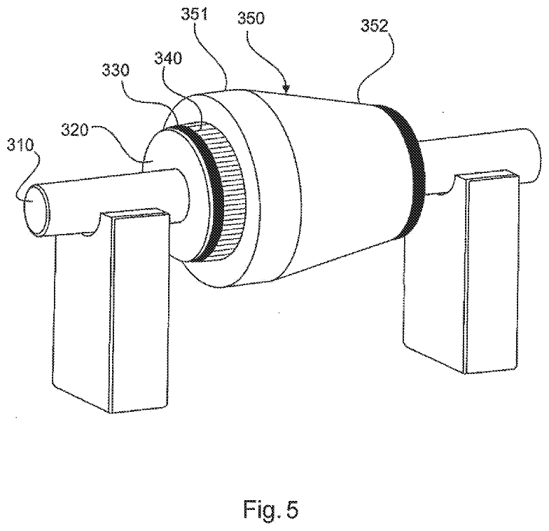

FIGS. 2 to 9 diagrammatically show various steps in the production of a component for a wind turbine. FIG. 2 shows a winding unit 300 having a shaft 310 and a winding core 320. By rotation of the shaft 310 the winding core is also rotated. As shown in FIG. 3 a vacuum film 330 can be provided around the winding core 320. Then as shown in FIG. 4 a fleece lattice structure 340 can be provided around the vacuum film 330.

A scrim is wound around the winding core 320 with the vacuum film 330 and the fleece lattice structure 340 so that a component 350 to be produced is wound. The component 350 can have a first end 351 and a second end 352, wherein the second end 352 can be at least partially of a conical configuration.

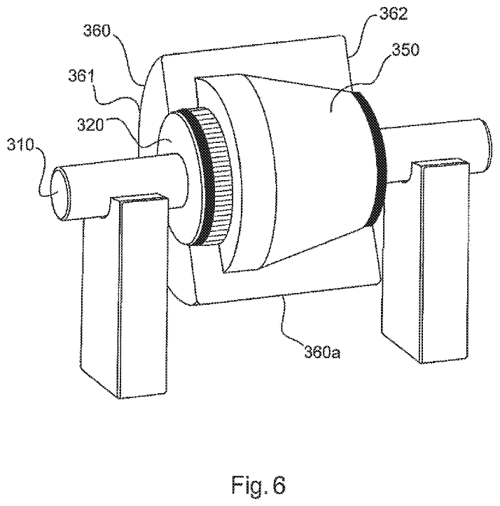

As can be seen in FIG. 6 an external mold 360 is placed around the winding core 320 and the wound component 350. As the external mold is a multi-part structure firstly a first half-shell portion of the external mold 360 can be set in place. A second half-shell portion can then surround the rest of the component 350.

FIG. 7 shows that the two half-shell portions which make up the external mold are placed around the component 350. They are vacuum-tightly closed relative to each other. The vacuum film 330 can be vacuum-tightly closed with the external mold and thus forms the infusion space into which the resin can be introduced.

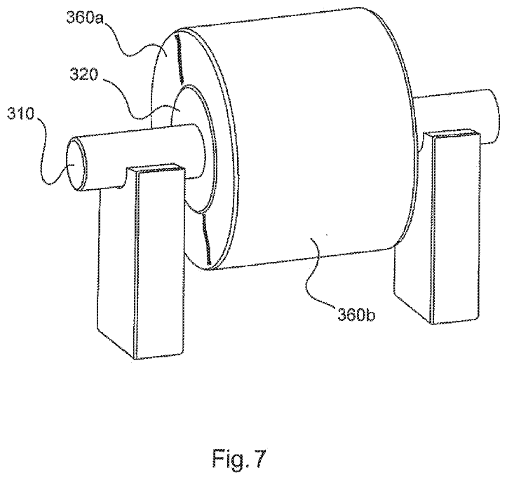

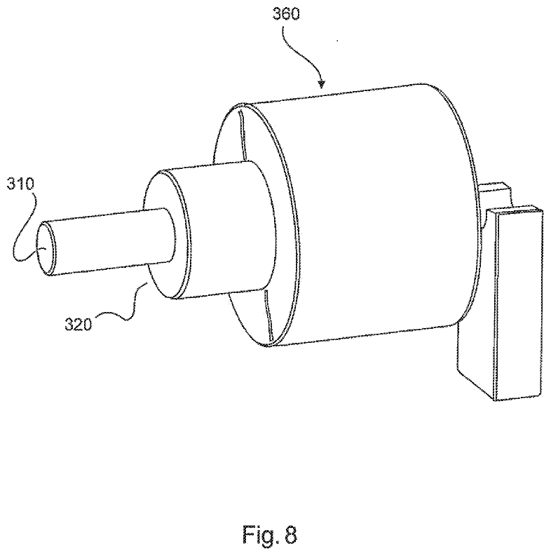

As can be seen in FIGS. 8 and 9 the winding core 320 can be completely removed with the shaft 310 so that only the external mold 360 with the component 350 disposed therein remains.

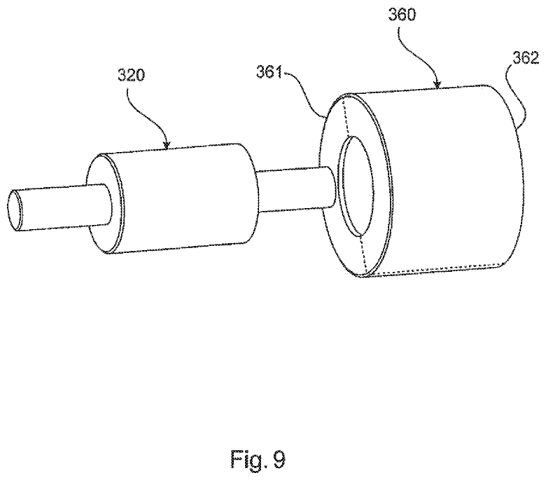

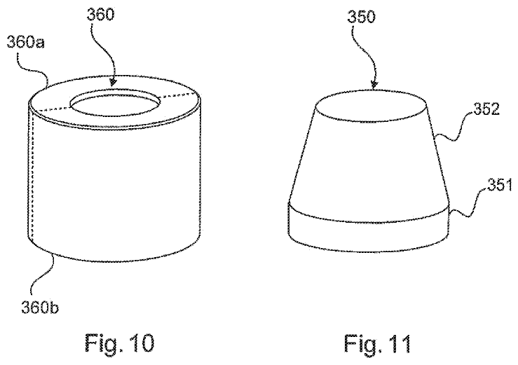

As can be seen from FIG. 10 the external mold can be removed with the component and a vacuum infusion method can be carried out to infuse the scrim of the wound component with resin. The resin can then be cured so that finally the finished component 350 is obtained, as can be seen from FIG. 11.

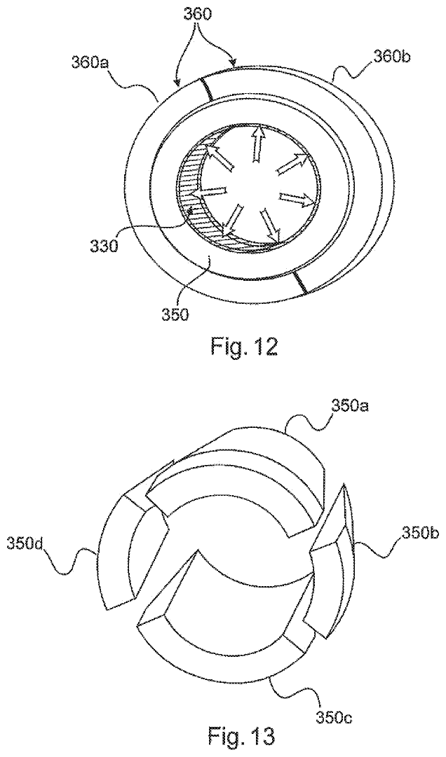

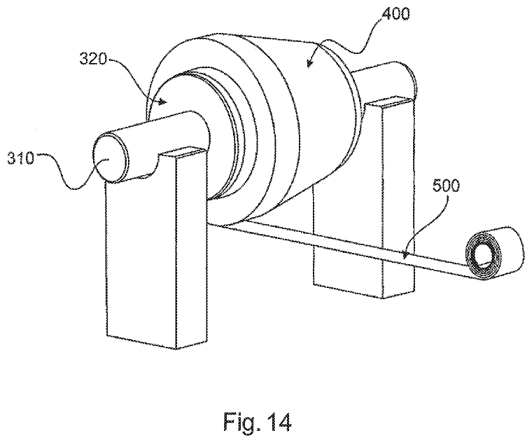

As shown in FIG. 12 the external mold can be at least of a two-part configuration. Optionally the external mold can also be of a multi-part configuration.

As can be seen from FIG. 13 the component 350 can be of a multi-part configuration by the wound component being cut into individual parts.

A vacuum film 330 is placed on the winding core 320. It is sealed off relative to the external mold which, as described above, is vacuum-tight in itself. Optionally a further vacuum film can be provided between the component and the external mold so that a vacuum can be created between the vacuum film and the external mold. That can have the result that the wound scrim 350 can relax outwardly. Optionally the winding core 320 can be removed before resin can diffuse into the wound scrim by means of the vacuum infusion method. That is advantageous because it is possible in that way to achieve a wave-free and fold-free external contour on the component.

The thickness of the wound scrim is typically less than the spacing between the winding core and the inside of the external mold so that the scrim is pressed against an internal wall of the external mold and thus a gap can occur between the scrim and the outer wall of the winding core 320. In that way the scrim can be tautened from the inside outwardly and the winding core 320 can be easily removed.

After a vacuum has been created between the vacuum film 330 and the inside of the outer mold, 360 the outer mold 360 can be removed from the winding core.

The winding core 320 can then be re-used in the interim to produce a further component 350.

According to the geometry of the shape to be wound the external mold 360 can be of a one-part configuration. As an alternative thereto the external mold can be of a multi-part configuration so that the individual parts of the external mold can be removed separately.

By way of example blade connection regions of a wind turbine rotor blade can be produced by preform segments. Those preform segments can be produced. In that way it is possible to avoid the components having defects in the form of folds or upset configurations at the external contour. That is achieved inter alia by the use of the vacuum infusion method.

Provided is a use of a (multi-part) positive external mold to produce wound components having a defined external geometry.

The component to be produced can represent inner and outer flange thickened portions, preform segments and internal rotor blades. As an alternative thereto spar boxes can be produced with the method.

The method allows effective and defect-free production of rotor blade components. In particular it is possible to save on cutting facilities for cutting to size and component molds. In addition fitting accuracy of the individual parts to each other and to adjoining shapes can be considerably improved.

1. A method of producing a component of a wind turbine, the method comprising:
providing a winding core on a rotatable shaft;
placing a vacuum film on the winding core;
winding fabric on the vacuum film using a winding scrim;
placing an external mold around the wound fabric;
creating a vacuum between the vacuum film and an inside of the external mold so that the wound-on scrim is pressed against the inside of the external mold;
introducing resin in the mold; and
curing the resin producing the component of the wind turbine.

2. The method according to claim 1 wherein the external mold is of a multi-part configuration.

3. The method according to claim 1 further comprising:
removing the winding core before the vacuum is created.

4. The method according to claim 1 further comprising:
severing the component of the wind turbine to provide separate individual segments.

5. A wind turbine rotor blade, comprising:
at least one component produced by the method according to claim 1.

6. The method according to claim 1 wherein the component of the wind turbine is a wind turbine rotor blade.
